(19) United States
(12) Patent Application Publication
(10) Pub. No.: US 2024/0049759 A1
(43) Pub. Date: Feb. 15, 2024

(54) PEA PROTEIN EMULSIFIER

(71) Applicant: CORN PRODUCTS DEVELOPMENT, INC., WESTCHESTER, IL (US)

(72) Inventors: Catherine BOMONT, Bridgewater, NJ (US); Carolyn JENNRICH, Bridgewater, NJ (US); NAGUL NAGULESWARAN, Bridgewater, NJ (US); Xin YANG, Bridgewater, NJ (US); Timothy YEUNG, Bridgewater, NJ (US); Christopher ZHANG, Bridgewater, NJ (US)

(21) Appl. No.: 18/257,658

(22) PCT Filed: Nov. 29, 2021
(86) PCT No.: PCT/US2021/060922

§ 371 Date: Jun. 15, 2023

Related U.S. Application Data
(60) Provisional application No. 63/126,339, filed on Dec. 16, 2020.

(51) Int. Cl. A23L 29/10; A23J 1/14; A23D 7/005

(52) U.S. Cl. CPC A23L 29/10; A23J 1/14; A23D 7/005

(57) ABSTRACT

The technology disclosed in this specification is directed to pea protein emulsifiers containing dissolved pea protein and oil-in-water emulsions containing the pea protein emulsifier and so having dissolved pea protein content. The pea protein emulsifiers can be made from protein remaining dissolved the process water of a pea protein isolation process. The disclosed dissolved pea protein emulsifiers make emulsions have good stability against oil separation.

The technology disclosed in this specification is directed to pea protein emulsifiers containing dissolved pea protein and oil-in-water emulsions containing the pea protein emulsifier.

Peas are a useful source of vegetable (non-meat) protein. Commonly, pea protein is isolated from peas (whether whole pea, split pea, or pea flour) in an aqueous process and is sold in powdered form. Protein isolation processes commonly recovery over 80% of the pea's protein, but at least part of the protein remains dissolved in the process water. The protein content of this process water can be further segregated and recovered using high pressure filtration, like microfiltration, ultrafiltration or reverse osmosis filtration. The fractions of proteins recovered from the process water of a pea protein isolation process have proved limited in their ability to make long term stable emulsions and improved emulsifiers are needed.

The technology disclosed in this specification is directed to an emulsifier comprising dissolved pea protein (called herein a dissolved pea protein emulsifier) and methods for making the emulsifier. The described dissolved pea protein emulsifiers are useful for making improved emulsions compared to emulsions made from the filtered fractions of pea protein isolation process water.

The technology disclosed in this specification can be better understood by reference to the following figures, which are provided for illustrative purposes only and are not intended to limit the full scope of the inventions disclosed in this specification.

### BRIEF DESCRIPTION OF THE FIGURES

FIG. 1 plots the mean oil droplet size of egg free emulsions made using dissolved pea protein emulsifiers having different protein contents.

FIG. 2 plots the oil droplet size distribution of egg free emulsions using dissolved pea protein emulsifiers having different protein content after the emulsion was stored for 24 hours at 5° C.

FIG. 3 plots the oil droplet size distribution of egg free emulsions using dissolved pea protein emulsifiers having the same protein content but obtained by different methods after the emulsion was stored for 24 hours at 5° C.

FIG. 4 plots the oil droplet size distribution of egg free emulsions made using dissolved pea protein emulsifiers having different sodium contents after the emulsion was stored for 24 hours at 5° C.

FIG. 5 plots the change in oil droplet size distribution of egg free emulsions made using dissolved pea protein emulsifiers having different sodium contents after the emulsion was stored for 3 months.

FIG. 6 depicts magnified images (200×, light microscopy) of egg free emulsions made using dissolved pea protein emulsifiers having different sodium contents.

In one aspect, the technology disclosed in this specification pertains to an oil-in-water emulsion made using a dissolved pea protein emulsifier. In any embodiment described in this specification, an oil-in-water emulsion comprises an oil, a dissolved pea protein emulsifier and an aqueous ingredient wherein the oil and dissolved pea protein emulsifier are present in a ratio of oil-to-dissolved pea protein of at least about 0.01-part dissolved pea protein to 1-part oil (by weight of the emulsion), or at least about 0.011-part dissolved pea protein to 1-part oil, or at about 0.012-part dissolved pea protein to 1-part oil; and wherein the emulsion is egg free.

In at least some embodiments, the emulsions described in this specification are high fat emulsion. In any embodiment, an emulsion described in this specification has an oil content of greater than about 65%, or from about 65% to about 80% or from about 60% to about 75%, or from about 70% to about 75%.

In other embodiments, such emulsions are low fat. In some embodiments disclosed in this specification an emulsion of oil and water comprises a) an oil in an amount of from about 25% to about 50% or from about 25% to about 40% or from about 25% to about 35%.

In any embodiment, an emulsion described in this invention may have any useful pH. In embodiments the emulsion has pH from about 3 to about 8, or from about 6.5 to about 8. In embodiments the emulsion is acidic and has a pH of less than 6.5, or less than about 5 or from about 3 to about 6.5, or from about 3 to about 5.

In any embodiment the dissolved pea protein in an emulsion is at least about 0.90% of the emulsion, or from about 0.70% to about 2% by weight of the emulsion of from about 0.80% to about 1.50% by weight of the emulsion. In any embodiment described in this specification, a dissolved pea protein emulsifier is used in an emulsion in an amount of from about 10% to 30% by weight of the emulsion or from about 10% to about 20%, or from about 15% to about 20%.

In any embodiment described in this specification, a dissolved pea protein emulsifier is a liquid composition having a dissolved protein content of from about 10% to about 40% or from about 15% to about 40% or about 20% to about 40%, or about 20% to about 35%. In any embodiment described in this specification, a dissolved pea protein emulsifier comprises dissolved pea protein having a distribution of molecular weights. In embodiments a dissolved pea protein emulsifier comprises a molecular weight distribution of dissolved proteins wherein at least 5% (by weight of the emulsifier) of proteins in the distribution have a molecular weight greater than about 30 kDa. In embodiments a dissolved pea protein emulsifier comprises a molecular weight distribution of proteins wherein at least 5% (by weight of the emulsifier) of proteins in the distribution have a molecular weight greater than about 40 kDa. In embodiments a dissolved pea protein emulsifier comprises a molecular weight distribution of proteins wherein from about 5% to about 20% (by weight of the emulsifier) of proteins in the distribution have a molecular weight greater between about 30 and 40 kDa, or from about 5% to about 15%.

Embodiments of a pea protein emulsifier may further comprise dissolved components naturally found in pea, for example including saponins. Saponins may be present in a dissolved pea protein emulsifier in amounts less than 0.1% or from about 0.01% to about 0.1% by weight of the emulsifier, or from about 0.01% to about 0.05%.

Emulsions using a dissolved pea protein emulsifier as claimed have good stability against oil separation with the use of added starch. In any embodiment, an emulsion as described in this specification, has no added starch. Dissolved pea protein emulsifiers may be starch free, although it is expected that in at least some processes used to obtain a dissolved pea protein emulsifier not all pea starch is removed. In any embodiment of an emulsion as described in this specification, the emulsion has no starch from a source other than pea.

The emulsions described in this specification have an oil droplet size distribution that has a small mean oil droplet size. In any embodiment, an emulsion described in this specification has a mean oil droplet size of less than about 15 microns, or less than about 10 microns, or from about 5 microns to about 10 microns.

The emulsions described in this specification are stable against separation without the addition of starch. In any embodiment disclosed in this specification, an emulsion does not comprise an added starch or amylopectin. Emulsions, as described in this specification, are stable against oil separation without the use of hydrocolloids or modified starch or fiber. In any embodiment described in this specification, an emulsion does not comprise a hydrocolloid or modified starch. In any embodiment described in this specification, the emulsion has a mean oil droplet size that changes by less than about 5 microns for at least 1 month, or 3 months or 6 months. In any embodiment described in this specification, an emulsion has a mean oil droplet size that changes by less than about 5 microns over 1 month, or 3 months, or 6 months when stored at one or more of 5° C. or 25° C.

In any embodiment described in this specification, an emulsion has a viscosity of from about 10,000 to about 50,000 cP, or from about 15,000 to about 30,000 cP, or from about 15,000 to about 25,000 cP. The foregoing viscosities are obtainable without the use of added modified starch, hydrocolloid or fiber.

In another aspect, the technology disclosed in this specification pertains to a process of making a dissolved pea protein emulsifier. In any embodiment described in this specification a method of making a pea protein emulsifier comprises: a) obtaining an aqueous composition comprising dissolved pea protein and having a pH of from about 6 to about 8; and b) concentrating the aqueous composition to have a pea protein content of greater than about 10%, or greater than about 15% or from about 10% to about 40%, or from about 15% to about 40%, or from about 20% to about 40%, or from about 20% to about 35% wherein the method does not comprise a microfiltration step or ultrafiltration step or reverse osmosis step. Notably applicants have found that within emulsions having equal protein concentration, emulsions made from dissolved pea protein emulsifiers produced using ultrafiltration, or microfiltration have generally larger mean oil droplet size compared to dissolved pea protein emulsifiers that do not include a microfiltration or ultrafiltration step.

Any suitable method for dissolving pea protein may be used to obtain a dissolved pea protein emulsifier. In any embodiment a starting material for obtaining a dissolved pea protein emulsifier is whole peas, split peas, milled peas, pea flour and fractions of pea flour (for example high protein pea flours, which may be called in the industry pea protein concentrates). In any embodiment described in this specification a method for making a dissolved pea protein emulsifier includes obtaining a milled or unmilled pea protein source, soaking the pea protein source to dissolve pea protein from the source. In any embodiment described in this specification, a method for making a dissolved pea protein emulsifier includes: dispersing a milled pea protein source having a pea starch and a pea fiber in an aqueous solution having a pH greater than about 8 or dispersing the milled pea protein source in an aqueous solution and adjusting the pH of the solution to a pH greater than about 8 to form a first dissolved fraction; separating starch and fiber from the first dissolved fraction; adjusting the pH of the first dissolved fraction to about 4 to about 5 to precipitate a portion of the pea protein in the first dissolved fraction, forming a second dissolved fraction and a precipitated; separating the precipitate from the second dissolved fraction and adjusting the pH of the second dissolved fraction to about 6 to about 8 to obtain an aqueous composition comprising a dissolved pea protein and concentrating the aqueous composition. A potential method with equipment for separating pea proteins from fibers and starches is disclosed in U.S. Pat. No. 5,972,119, which is incorporated here by reference. In any embodiment described in this specification, a method for making a dissolved pea protein emulsifier does not include a hydrolysis step.

In any embodiment described in this specification, a second dissolved fraction is adjusted from a pH of about 4 to about 5 to a pH of about 6 to about 8 by adding an alkaline agent like sodium hydroxide. In such processes, the sodium remains in the dissolved pea protein emulsifier. It has been found that dissolved pea protein emulsifiers having sodium can make high quality oil-in-water emulsions without removing the sodium. In any embodiment, a method for making a dissolved pea protein emulsifier does not comprise a dialysis step.

It has also been found that salt content of a dissolved pea protein emulsifier affects the quality of the emulsion, as emulsions using an emulsifier having higher salt content have increased mean oil droplet size compared to lower salt content versions of the dissolved pea protein emulsifier. Some embodiments of a method for making a dissolved pea protein emulsifier further comprise a dialysis step. In at least some embodiments of a method for making a dissolved pea protein emulsifier described in this specification, the emulsifier is made by a process that includes a dialysis step prior to concentrating an aqueous composition of dissolved pea protein to obtain the dissolved pea protein emulsifier.

This specification also discloses dissolved pea protein emulsifiers made from, obtained from, or obtainable by any process described in this specification. This specification also discloses dissolved pea protein emulsifiers. In any embodiment a dissolved pea protein emulsifier described in this specification has a sodium content or a potassium content less than about 1.5% by weight of the emulsifier, or less than about 1.2% or from about 0.7% to about 1.2% or from about 1.0% to about 1.2%. It is noted that sodium hydroxide may be used to increase the pH pea protein material, such as a milled pea composition or pea flour, to improve dissolution of the pea protein and to facilitate separating pea protein from pea starch and pea fiber within the flour or milled pea composition. Other food grade alkaline substances can also be used to adjust the pH. It has been observed that the functionality of recovered pea protein (both the precipitated as a pea protein isolate and dissolved in a pea protein emulsifier) is unaffected by using potassium hydroxide during a pea protein separation process instead of sodium hydroxide. Use of potassium hydroxide instead of sodium hydroxide further has the advantage of making a low sodium pea protein isolate and dissolved pea protein emulsifier without the need for dialysis to remove the sodium.

This specification also discloses use of any described dissolved pea protein emulsifier to make the emulsion described in this specification. The emulsions described in this specification are oil-in-water emulsions but are not limited to any oil or mixture of oils or to any aqueous ingredient or mixtures of aqueous ingredients. All edible oils and aqueous ingredients may be used in emulsions of described in this specification. The emulsions may include flavoring, colorants, fragrances, and seasonings. It is expected that even when using a low salt dissolved pea protein emulsifier (for example a dissolved pea protein emulsifier made using a dialysis step) that the final emulsions may include salts, like sodium chloride, or others commonly used in emulsions. Emulsions described in this specification may also include ingredients added to change texture, viscosity, or other organoleptic property of the emulsion. Such ingredients include hydrocolloids (gums and gum-like substances) modified fibers such as carboxymethyl cellulose or hydroxypropyl methyl cellulose; physically and chemically modified starches (including but not limited to thermally inhibited starches and chemically crosslinked starches). In any embodiment an emulsion, as described in this specification includes a thermally inhibited starch in an amount from about 0.75% to about 1.25%.

The emulsions described in this specification are not limited to any type of emulsion, but at least some embodiments are edible emulsions, like sauces, dressing, condiments, mayonnaise and similar compositions.

Reference to “hydrolysis” in this specification means an intentional process used to reduce the size of a protein. Hydrolysis reactions commonly involve acid or enzyme to cleave bonds between amino acids.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification is further described with reference to the following aspects, which are intended to be illustrative only and do not limit the full scope of the invention.

In a first aspect, the technology disclosed in this specification pertains to a dissolved pea protein emulsifier comprising: pea protein dissolved in an aqueous solution, wherein the dissolved pea protein has a molecular weight distribution of proteins wherein at least 5% (by weight of the emulsifier) of dissolved proteins in the distribution have a molecular weight greater than about 30 kDa.

In a second aspect, the technology disclosed in this specification pertains to the dissolved pea protein emulsifier of the first aspect having a molecular weight distribution of dissolved proteins wherein at least 5% (by weight of the emulsifier) of dissolved proteins in the distribution have a molecular weight greater than about 40 kDa.

In a third aspect, the technology disclosed in this specification pertains to the dissolved pea protein emulsifier of the first or second aspects having a molecular weight distribution of dissolved proteins wherein from about 5% to about 20% (by weight of the emulsifier) of dissolved proteins in the distribution have a molecular weight greater between about 30 kDa and 40 kDa, or from about 5% to about 15%.

In a fourth aspect, the technology disclosed in this specification pertains to the dissolved pea protein emulsifier of any one of the first to third aspects having a sodium content or a potassium content less than about 1.5% by weight of the emulsifier, or less than about 1.2% or from about 0.7% to about 1.2% or from about 1.0% to about 1.2%.

In a fifth aspect, the technology disclosed in this specification pertains to the dissolved pea protein emulsifier of any one of the first to fourth aspects having a saponin content from pea of from about 0.01% to about 0.1% by weight of the emulsifier, or from about 0.01% to about 0.05% by weight of the emulsifier.

In a sixth aspect, the technology disclosed in this specification pertains to the dissolved pea protein emulsifier of any one of the first to fifth aspects wherein the emulsifier is made by a process made by a process comprising: obtaining an aqueous composition comprising dissolved pea protein and having a pH of from about 6 to about 8; and concentrating the aqueous composition to have a pea protein content of greater than about 10%, or greater than about 20% or from about 10% to about 40%, or from about 15% to about 40% or from about 20% to about 40% or from about 20% to about 35%; wherein the method does not comprise a microfiltration step or ultrafiltration step, or a reverse osmosis step.

In a seventh aspect, the technology disclosed in this specification pertains to the dissolved pea protein emulsifier of any one of the first to sixth aspects wherein the emulsifier is made by a process does not comprise a dialysis step.

In an eighth aspect, the technology disclosed in this specification pertains to the dissolved pea protein emulsifier of any one of the first to seventh aspects wherein the emulsifier is made by a process further comprises a dialysis step.

In a ninth aspect, the technology disclosed in this specification pertains to the dissolved pea protein emulsifier of any one of the first to eighth aspects wherein the emulsifier is made by a process further comprises: obtaining a milled or unmilled pea protein source and soaking the pea protein source to dissolve a portion of the pea protein.

In a tenth aspect, the technology disclosed in this specification pertains to the dissolved pea protein emulsifier of any one of the first to ninth aspects wherein the emulsifier is made by a process further comprising: prior to the obtaining the aqueous composition step: (i) dispersing a milled pea protein source having a pea starch and a pea fiber in an aqueous solution having a pH greater than about 8 or dispersing the milled pea protein source in an aqueous solution and adjusting the pH of the solution to a pH greater than about 8 to dissolve a portion of the pea protein, forming a first dissolved portion; (ii) separating starch and fiber from the first dissolved portion; (iii) adjusting the pH of the first dissolved portion to from about 4 to about 5 to precipitate a portion of the protein in the first dissolved portion, forming a second dissolved portion and a precipitate; (iv) separating the precipitate from the second dissolved portion; and (v) adjusting the pH of the second dissolved portion to about 6 to about 8 to obtain the aqueous composition.

In an eleventh aspect, the technology disclosed in this specification pertains to the dissolved pea protein emulsifier of any one of the first to tenth aspects wherein the emulsifier is made by a process further comprises dialyzing the aqueous composition before the concentrating step.

In a twelfth aspect, the technology disclosed in this specification pertains to the dissolved pea protein emulsifier of any one of the first to eleventh aspects wherein the emulsifier is made by a process does not include a hydrolysis step.

In a thirteenth aspect, the technology disclosed in this specification pertains to an oil-in-water emulsion comprising: a) an oil; b) a dissolved pea protein emulsifier and c) an aqueous ingredient; wherein the oil and dissolved pea protein emulsifier are in an oil-to-dissolved pea protein ratio of about 0.01-part pea protein to about 1-part oil (by weight of the emulsion), or about 0.011-part pea protein to about 1-part oil, or about from about 0.12-part pea protein to about 1-part oil; and wherein the emulsion is egg free.

In a fourteenth aspect, the technology disclosed in this specification pertains to the emulsion of the thirteenth aspect wherein the oil is used in an amount greater than about 65% (by weight of the emulsion), or from about 65% to about 80% or from about 60% to about 75%, or from about 70% to about 75%.

In a fifteenth aspect, the technology disclosed in this specification pertains to the emulsion of the thirteenth or fourteenth aspects wherein the oil is used in an amount from about 25% to about 50% (by weight of the emulsion), or from about 25% to about 40% or from about 25% to about 35%.

In a sixteenth aspect, the technology disclosed in this specification pertains to the emulsion of any one of the thirteenth to fifteenth aspects wherein the dissolved pea protein is used in an amount of at least about 0.70% by weight of the emulsion, or at least about 0.90% of the emulsion, or from about 0.70% to about 2.0% by weight of the emulsion or from about 0.8% to about 1.5% by weight of the emulsion.

In a seventeenth aspect, the technology disclosed in this specification pertains to the emulsion of any one of the thirteenth to sixteenth aspects further having no starch from a source other than pea.

In an eighteenth aspect, the technology disclosed in this specification pertains to the emulsion of any one of the thirteenth to seventeenth aspects further having no added starch.

In a nineteenth aspect, the technology disclosed in this specification pertains to the emulsion of any one of the thirteenth to eighteenth aspects having a mean oil droplet size of less than about 15 microns, or less than about 10 microns, or from about 5 microns to about 10 microns.

In a twentieth aspect, the technology disclosed in this specification pertains to the emulsion of any one of the thirteenth to nineteenth aspects wherein the emulsion does not comprise a hydrocolloid or modified starch.

In a twenty-first aspect, the technology disclosed in this specification pertains to the emulsion of any one of the thirteenth to twentieth aspects having a pH of less than 6.5, or less than about 5 or from about 3 to about 6.5, or from about 3 to about 5.

In a twenty-second aspect, the technology disclosed in this specification pertains to the emulsion of any one of the thirteenth to twenty-first aspects having a viscosity of from about 10,000 to about 50,000 cP, or from about 15,000 to about 30,000 cP, or from about 15,000 to about 25,000 cP.

In a twenty-third aspect, the technology disclosed in this specification pertains to the emulsion of any one of the thirteenth to twenty-second aspects wherein the pea protein emulsifier is used in an amount of from about 10% to about 20% by weight of the emulsion or from about 15% to about 20%.

In a twenty-fourth aspect, the technology disclosed in this specification pertains to the emulsion of any one of the thirteenth to twenty-third aspects wherein the mean oil droplet size within the emulsion changes by less than about 5 microns for at least 1 month, or 3 months or 6 months.

In a twenty-fifth aspect, the technology disclosed in this specification pertains to the emulsion of any one of the thirteenth to twenty-fourth aspects having a mean oil droplet size that changes by less than about 5 microns over at least 1 month, or 3 months or 6 months when stored at about 5° C.

In a twenty-sixth aspect, the technology disclosed in this specification pertains to the emulsion of any one of thirteenth to twenty-fifth aspect having a mean oil droplet size that changes by less than about 5 microns over at least 1 month, or 3 months, or 6 months when stored at about 25° C.

In a twenty-seventh aspect, the technology disclosed in this specification pertains to the emulsion of any one of the thirteenth to twenty-sixth aspects wherein the dissolved pea protein emulsifier is made in a process that does not comprise an ultrafiltration step.

In a twenty-eighth aspect, the technology disclosed in this specification pertains to the emulsion of any one of the thirteenth to twenty-seventh aspects wherein the emulsion does not comprise a hydrocolloid or fiber.

In a twenty-ninth aspect, the technology disclosed in this specification pertains to the emulsion of any one of the thirteenth to twenty-eighth aspects wherein further comprising a thermally inhibited starch in an amount of from about 0.75% to about 1.25% by weight.

In a thirtieth aspect, the technology disclosed in this specification pertains to the emulsion of any one of the thirteenth to twenty-ninth aspects wherein the emulsion does not comprise an added starch or amylopectin.

In a thirty-first, the technology disclosed in this specification pertains to a method of making a pea protein emulsifier comprising: obtaining an aqueous composition comprising dissolved pea protein and having a pH of from about 6 to about 8; and concentrating the aqueous composition to have a pea protein content of greater than about 10%, or greater than about 20% or from about 10% to about 40% or from about 15% to about 40% or from about 20% to about 40% or from about 20% to about 35%; wherein the method does not comprise a microfiltration step or ultrafiltration step or reverse osmosis step.

In a thirty-second aspect, the technology disclosed in this specification pertains to the method of the thirty-first aspect wherein the method does not comprise a dialysis step.

In a thirty-third aspect, the technology disclosed in this specification pertains to the thirty-first or thirty-second aspects further comprising a dialysis step.

In a thirty-fourth aspect, the technology disclosed in this specification pertains to the method of any one of the thirty-first to thirty-third aspects wherein the emulsifier has a sodium content or a potassium content less than about 1.5% by weight of the emulsifier, or less than about 1.2% or from about 0.7% to about 1.2% or from about 1.0% to about 1.2%.

In a thirty-fifth aspect, the technology disclosed in this specification pertains to the method of any one of the thirty-first to thirty-fourth aspects further comprising: obtaining a milled or unmilled pea protein source and soaking the pea protein source to obtain a dissolved pea protein.

In a thirty-sixth aspect, the technology disclosed in this specification pertains to the method of any one of the thirty-first to thirty-fifth aspects wherein the process further comprises: prior to the obtaining the aqueous composition step: (i) dispersing a milled pea protein source having a pea starch and a pea fiber in an aqueous solution having a pH greater than about 8 or dispersing the milled pea protein source in an aqueous solution and adjusting the pH of the solution to a pH greater than about 8 to dissolve a portion of the pea protein, forming a first dissolved portion; (ii) separating starch and fiber from the first dissolved portion; (iii) adjusting the pH of the first dissolved portion to about 4 to about 5 to precipitate a portion of the protein in the first dissolved portion, forming a second dissolved portion and a precipitate; (iv) separating the precipitate from the second dissolved portion; and (v) adjusting the pH of the second dissolved portion to about 6 to about 8 to obtain the aqueous composition.

In a thirty-seventh aspect, the technology disclosed in this specification pertains to the method of any one of the thirty-first to thirty-sixth aspects wherein the aqueous composition is dialyzed before the concentration step.

In a thirty-eighth aspect, the technology disclosed in this specification pertains to the method of any one of the thirty-first to thirty-seventh aspects wherein the method does not include a hydrolysis step.

In a thirty-ninth aspect, the technology disclosed in this specification pertains to a use of a dissolved pea protein emulsifier of any foregoing claim in an emulsion as described in any foregoing claim.

In a fortieth aspect, the technology disclosed in this specification pertains to the use of a dissolved pea protein pea protein emulsifier as recited in the thirty-ninth aspect to obtain an emulsion having a mean oil droplet size of less than about 15 microns, or less than about 10 microns, or from about 5 microns to about 10 microns.

In a forty-first aspect, the technology disclosed in this specification pertains to the use of a dissolved pea protein emulsifier as recited in the thirty-ninth or fortieth aspects to obtain an emulsions further having a viscosity of from about 10,000 to about 50,000 cP, or from about 15,000 to about 30,000 cP, or from about 15,000 to about 25,000 cP.

In a forty-second aspect, the technology disclosed in this specification pertains to the use of the dissolved pea protein emulsifier as recited in any one of the thirty-ninth to forty-first aspects wherein the emulsion has a mean oil droplet size that changes by less than about 5 microns for at least 1 month, or 3 months or 6 months.

In a forty-third aspect, the technology disclosed in this specification pertains to the use of the dissolved pea protein emulsifier as recited in any one of the thirty-ninth to forty-second aspects wherein the emulsion has a mean oil droplet size that changes by less than about 5 microns over at least 1 month, or 3 months or 6 months when stored at 25° C.

In a forty-fourth aspect, the technology disclosed in this specification pertains to the use of the dissolved pea protein emulsifier as recited in any one of the thirty-ninth to forty-third aspects wherein the emulsion has a mean oil droplet size that changes by less than about 5 microns over at least 1 month, or 3 months, or 6 months when stored at 5° C.

In a forty-fifth aspect, the technology disclosed in this specification pertains to the use of the dissolved pea protein emulsifier as recited in any one of the thirty-ninth to forty-fourth aspects wherein the emulsifier has a molecular weight distribution of dissolved proteins wherein at least about 5% (by weight of the emulsifier) of dissolved proteins in the distribution have a molecular weight greater than about 30 kDa.

In a forty-sixth aspect, the technology disclosed in this specification pertains to the use of the dissolved pea protein emulsifier as recited in any one of the thirty-ninth to forty-fifth aspects wherein the dissolved pea has a molecular weight distribution of dissolved proteins wherein at least about 5% (by weight of the emulsifier) of dissolved proteins in the distribution have a molecular weight greater than about 40 kDa.

In a forty-seventh aspect, the technology disclosed in this specification pertains to the use of the dissolved pea protein emulsifier as recited in any one of the thirty-ninth to forty-sixth aspects wherein the dissolved pea has a molecular weight distribution of dissolved proteins wherein from 5% to 20% (by weight of the emulsifier) or from about 5% to about 15% of dissolved proteins in the distribution have a molecular weight greater between about 30 kDa and 40 kDa.

In a forty-eighth aspect, the technology disclosed in this specification pertains to the use of the dissolved pea protein emulsifier as recited in any one of the thirty-ninth to forty-seventh aspects having a sodium content or a potassium content less than about 1.5% by weight of the emulsifier, or less than about 1.2% or from about 0.7% to about 1.2% or from about 1.0% to about 1.2%.

In a forty-ninth aspect, the technology disclosed in this specification pertains to the use of the dissolved pea protein emulsifier as recited in any one of the thirty-ninth to forty-eighth aspects having a saponin content from pea of from 0.01% to 0.1% by weight of the emulsifier, or from about 0.01% to about 0.05% by weight of the emulsifier.

In a fiftieth aspect, the technology disclosed in this specification pertains to a dissolved pea protein emulsifier comprising: pea protein dissolved in an aqueous solution, wherein the dissolved pea protein has a molecular weight distribution of proteins wherein at least 5% (by weight of the emulsifier) of dissolved proteins in the distribution have a molecular weight greater than about 30 kDa wherein, optionally, the dissolved pea protein has a molecular weight distribution of proteins wherein about 5% to about 20% (by weight of the emulsifier) of dissolved proteins in the distribution have a molecular weight greater between about 30 kDa and 40 kDa, or from about 5% to about 15%.

In a fifty-first aspect, the technology disclosed in this specification pertains to a dissolved pea protein emulsifier as described in the fiftieth aspect having a sodium content or a potassium content less than about 1.5% by weight of the emulsifier, or less than about 1.2% or from about 0.7% to about 1.2% or from about 1.0% to about 1.2% wherein, optionally a saponin content from pea of from about 0.01% to about 0.1% by weight of the emulsifier, or from about 0.01% to about 0.05% by weight of the emulsifier.

In a fifty-second aspect, the technology disclosed in this specification pertains to the dissolved pea protein emulsifier of fiftieth or fifty-first aspects having a pea protein content of greater than about 10%, or greater than about 20% or from about 10% to about 40%, or from about 15% to about 40% or from about 20% to about 40% or from about 20% to about 35%.

In a fifty-third aspect, the technology disclosed in this specification pertains to the dissolved pea protein emulsifier of fiftieth to fifty-second aspects wherein the emulsifier is made by a process comprising: (i) obtaining a dispersion of a milled pea protein source having a pea starch and a pea fiber in an aqueous solution wherein the dispersion has a pH greater than about 8 or dispersing the milled pea protein source in an aqueous solution and adjusting the pH of the solution to a pH greater than about 8 to dissolve a portion of the pea protein, forming a first dissolved portion; (ii) separating starch and fiber from the first dissolved portion; (iii) adjusting the pH of the first dissolved portion to from about 4 to about 5 to precipitate a portion of the protein in the first dissolved portion, forming a second dissolved portion and a precipitate; (iv) separating the precipitate from the second dissolved portion; and (v) adjusting the pH of the second dissolved portion to about 6 to about 8 to obtain the aqueous composition wherein the emulsifier is made by a process does not include a hydrolysis step, a microfiltration step, an ultrafiltration step, or a reverse osmosis step.

In a fifty-fourth aspect, the technology disclosed in this specification pertains to an oil-in-water emulsion comprising: a) an oil; b) a dissolved pea protein emulsifier and c) an aqueous ingredient; wherein the oil and dissolved pea protein emulsifier are in an oil-to-dissolved pea protein ratio of about 0.01-part pea protein to about 1-part oil (by weight of the emulsion), or about 0.011-part pea protein to about 1-part oil, or about from about 0.12-part pea protein to about 1-part oil; and wherein the emulsion is egg free.

In a fifty-fifth aspect, the technology disclosed in this specification pertains to the emulsion of the fifty-fourth aspect wherein the oil is used in an amount) in a range selected from the group consisting of: a) greater than about 65% (by weight of the emulsion), or from about 65% to about 80% or from about 60% to about 75%, or from about 70% to about 75%; and b) from about 25% to about 50% (by weight of the emulsion), or from about 25% to about 40% or from about 25% to about 35%.

In a fifty-sixth aspect, the technology disclosed in this specification pertains to the emulsion of the fifty-fourth or fifty-fifth aspects wherein the dissolved pea protein is used in an amount of at least about 0.70% by weight of the emulsion, or at least about 0.90% of the emulsion, or from about 0.70% to about 2.0% by weight of the emulsion or from about 0.8% to about 1.5% by weight of the emulsion.

In a fifty-seventh aspect, the technology disclosed in this specification pertains to the emulsion of the fifty-fourth to fifty-sixth aspects further having no added starch.

In a fifty-eighth aspect, the technology disclosed in this specification pertains to the emulsion of the fifty-fourth to fifty-seventh aspects having a mean oil droplet size of less than about 15 microns, or less than about 10 microns, or from about 5 microns to about 10 microns.

In a fifty-ninth aspect, the technology disclosed in this specification pertains to the emulsion of the fifty-fourth to fifty-eighth aspects wherein the emulsion does not comprise a hydrocolloid or modified starch.

In a sixtieth aspect, the technology disclosed in this specification pertains to a method of making a pea protein emulsifier comprising: obtaining an aqueous composition comprising dissolved pea protein and having a pH of from about 6 to about 8; and concentrating the aqueous composition to have a pea protein content of greater than about 10%, or greater than about 20% or from about 10% to about 40% or from about 15% to about 40% or from about 20% to about 40% or from about 20% to about 35%; wherein the method does not comprise a microfiltration step or ultrafiltration step or reverse osmosis step.

In a sixty-first aspect, the technology disclosed in this specification pertains to method of the sixtieth aspect wherein the method does not comprise a dialysis step.

In a sixty-second aspect, the technology disclosed in this specification pertains to the method of they sixtieth or sixty-first aspect wherein the emulsifier has a sodium content or a potassium content less than about 1.5% by weight of the emulsifier, or less than about 1.2% or from about 0.7% to about 1.2% or from about 1.0% to about 1.2%.

In a sixty-third aspect, the technology disclosed in this specification pertains to the method of they sixtieth to sixty-second aspect wherein the process further comprises: prior to the obtaining the aqueous composition step: (i) dispersing a milled pea protein source having a pea starch and a pea fiber in an aqueous solution having a pH greater than about 8 or dispersing the milled pea protein source in an aqueous solution and adjusting the pH of the solution to a pH greater than about 8 to dissolve a portion of the pea protein, forming a first dissolved portion; (ii) separating starch and fiber from the first dissolved portion; (iii) adjusting the pH of the first dissolved portion to about 4 to about 5 to precipitate a portion of the protein in the first dissolved portion, forming a second dissolved portion and a precipitate; (iv) separating the precipitate from the second dissolved portion; and (v) adjusting the pH of the second dissolved portion to about 6 to about 8 to obtain the aqueous composition.

In a sixty-fourth aspect, the technology disclosed in this specification pertains to the method of they sixtieth to sixty-third aspect wherein the process further comprises wherein the method does not include a hydrolysis step.

In a sixty-fifth aspect the technology disclosed in this specification pertains to the use of a dissolved pea protein emulsifier of any foregoing aspect in an emulsion as described in any foregoing aspect.

In a sixty-sixth aspect the technology disclosed in this specification pertains to the use of a dissolved pea protein emulsifier as recited in the sixty-fifth aspect to obtain an emulsion having a mean oil droplet size of less than about 15 microns, or less than about 10 microns, or from about 5 microns to about 10 microns.

In a sixty-seventh aspect the technology disclosed in this specification pertains to the use of the dissolved pea protein emulsifier as recited in any one of the sixty-fifth to sixty-sixth aspects wherein the emulsion has a mean oil droplet size that changes by less than about 5 microns over at least 1 month, or 3 months or 6 months when stored at 25° C.

In a sixty-eighth aspect the technology disclosed in this specification pertains to the use of the dissolved pea protein emulsifier as recited in any one of the sixty-fifth to sixty-seventh aspects wherein the emulsion has a mean oil droplet size that changes by less than about 5 microns over at least 1 month, or 3 months, or 6 months when stored at 5° C.

In a sixty-ninth aspect the technology disclosed in this specification pertains to the use of the dissolved pea protein emulsifier as recited in any one of the sixty-fifth to sixty-eighth aspects wherein the emulsifier has a molecular weight distribution of dissolved proteins wherein from 5% to 20% (by weight of the emulsifier) or from about 5% to about 15% of dissolved proteins in the distribution have a molecular weight greater between about 30 kDa and 40 kDa.

The technology disclosed in this specification is further described with reference to the following examples, which are intended to be illustrative only and do not limit the full scope of the invention.

### EXAMPLE 1—EMULSION FORMULA

Efficacy of an emulsifier in an oil-in-water emulsion can be evaluated by measuring oil droplet size distribution. It is desired for higher quality emulsions to have a narrow distribution of oil droplet sizes and a small mean oil droplet size because smaller oil droplets more easily disperse in the aqueous phase. Also emulsion stability against oil separation can be evaluated by monitoring changes (generally increases) in mean oil droplet size over time. Increasing mean oil droplet size indicates coalescing of the oil and precedes separation between the oil and water phases.

One set of emulsions studied in the following examples were made using the formula provided in Table 1, which is an example of a high fat emulsion.

TABLE 1
Emulsion formula for analysis of concentrated
pea protein emulsifiers

| Ingredient | Wt. % |
|---|---|
| Dissolved Pea Protein Emulsifier (liquid) | 15.399% |
| Water | 7.500% |
| Soybean Oil | 70.000% |
| Potassium Sorbate | 0.100% |
| Ethylenediaminetetraacetic acid (EDTA) | 0.001% |
| Salt | 1.000% |
| Sugar | 3.000% |
| Vinegar | 3.000% |
| TOTAL | 100% |

### EXAMPLE 2—PROCEDURES

Liquid dissolved pea protein emulsifiers can be obtained by various processes that soak pea material (e.g. whole pea, split pea, pea flour etc.) in aqueous solutions to dissolve a soluble pea protein fraction, obtaining a dissolved pea protein solution, and then to separating the dissolved pea protein solution from remaining insoluble pea material. An illustrative process follows. Split peas were milled to obtain flour, which was dispersed in aqueous solution. The pH of the aqueous dispersion was raised to greater than 8 to facilitate dissolution of the proteins. Pea starch and pea fiber were separated from a supernatant comprising dissolved pea protein. The pH of the supernatant was reduced to about 4.5 to precipitate a fraction of pea protein for to form a powdered pea protein isolate. After allowing protein to precipitate from solution, the supernatant, which contains a fraction of still dissolved pea protein, is separated from the precipitated protein. The supernatant was then concentrated using evaporation to obtain a set of pea protein emulsifiers having different dissolved protein content.

Emulsions made were made from the set of dissolved pea protein emulsifiers as follows: Aqueous ingredients (emulsifier, water, and vinegar) were mixed in a conventional kitchen stand mixer mixing bowl. Dry ingredients were added to the aqueous mixture and mixed until homogenous. Oil was added slowly while mixing at medium speed. The mass was then transferred to a high shear mixer for homogenization (30 hertz for 2 minutes).

Droplet size was measured using a Beckman Coulter LS 13 320 SW Laser Based Particle Size Analyzer.

Molecular weight was measured using sodium dodecyl sulfate polyacrylamide gel electrophoresis (SDS-PAGE) with added reducing agent (dithiothreitol) on stain-free gel (4-20% gradient in polymer crosslinking).

Saponins were quantified by the following process: metabolites were extracted from the freeze-dried samples (800 mg) with 8 mL 80:20 methanol to water mixture, gently shaken at 2° C. for 30 min, before centrifugation at 16000 g for 30 min at 4° C. The resulting solutions were injected (1 μL) onto a reverse-phase column for liquid chromatography-mass spectrometry (LS/MS) (electrospray ionization tandem mass spectrometry MS/MS) using a ultra-performance liquid chromatography coupled to a quadrupole time of flight.

Protein content of protein emulsifier before adding into an emulsion system was measured using a Dumas combustion method using a LECO analyzer.

### EXAMPLE 3—EFFECT OF PROTEIN CONTENT ON OIL DROPLET SIZE

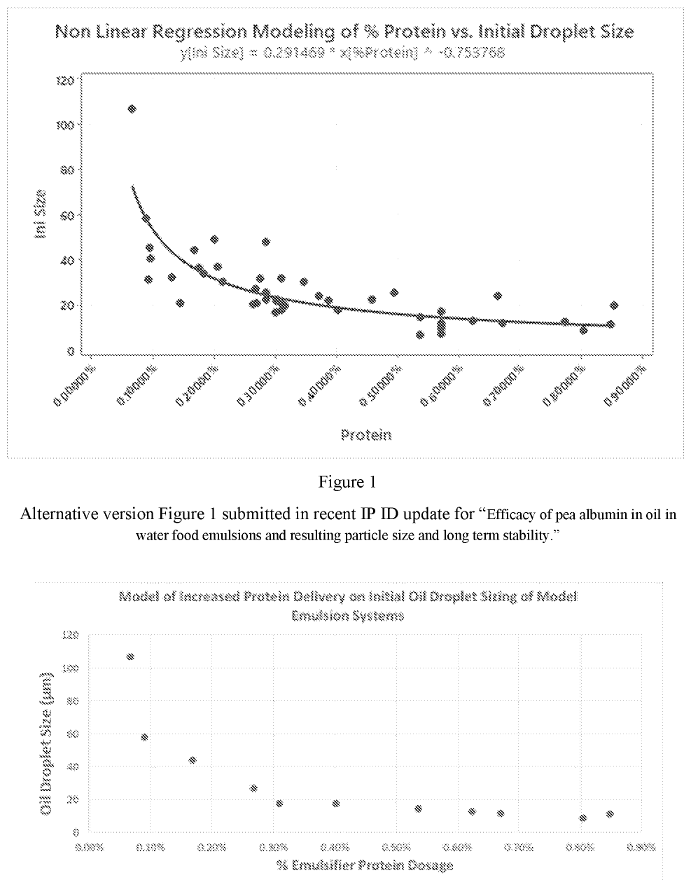

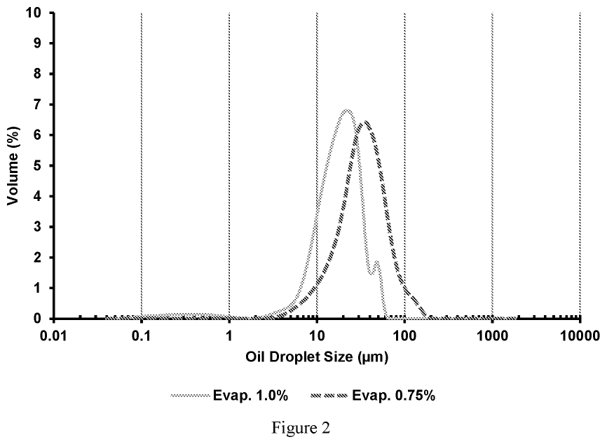

Emulsions using the formula of Table 1 were made using dissolved pea protein emulsifiers having different protein contents, to obtain emulsions having a protein content ranging from 0.10% to 0.90%. Protein content in the emulsifiers was obtained by evaporating a soluble fraction of pea protein, like described Example 2. Mean oil droplet size was measured and a graph of mean oil droplet size versus protein content is depicted in FIG. 1. A non-linear regression modelling was applied to guide the trend but was not necessary to represent the relationship between two parameters. As seen in FIG. 1, emulsion oil droplet size decreased as protein content in the emulsion increased. More specifically, within the 70% oil emulsions of the formula of Table 1, the emulsions having mean oil droplet size of about 10 microns were obtained using pea protein emulsifiers having about 0.90% protein content. FIG. 2 graphs the oil droplet size distribution of emulsions having protein content of 0.75% or 1.0%, both made using dissolved pea protein emulsifier evaporated to different protein content. Oil droplet size (microns) is on the x-axis and percent of the distribution of the droplets is plotted on the y-axis. As seen in FIG. 2, the emulsion having protein content of 1.0% had generally smaller oil droplet size than the emulsion having a protein content of 0.75%.

Additionally, Table 2 reports approximate mean oil droplet size values versus pea protein content of the pea protein emulsifier and, calculated based on usage described in Table 1, the amount of protein in the emulsions per percent oil usage.

TABLE 2
Correlation protein content in a protein emulsion
with oil load and oil droplet size

| | Protein content in | Protein content in |
|---|---|---|
| | emulsion wt. % | model system |
| Oil droplet size | (from pea emulsifier) | per 1% oil load |
| About 10 micron | 0.90% | 0.0129% |
| About 15 microns | 0.53% | 0.0076% |
| About 20 microns | 0.36% | 0.0051% |

The above shows that to obtain an oil-in-water emulsion having mean oil droplet size of about 10 microns uses at least about 0.0129-parts pea protein per 1-part oil.

### EXAMPLE 4—QUALITY OF EMULSIONS MADE USING VARIOUS SEPARATION METHODS

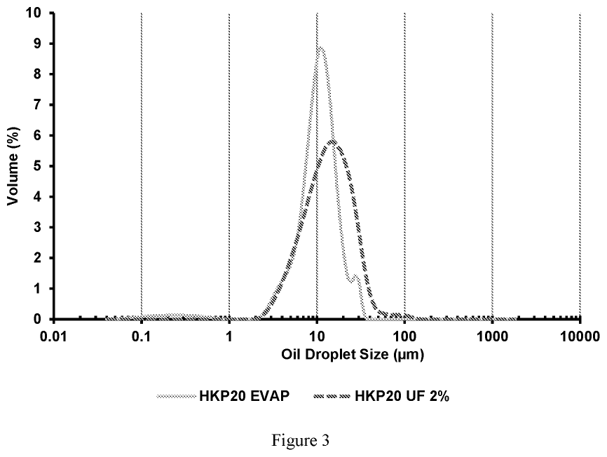

A soluble fraction of dissolved pea protein was obtained as described in Example 2. The retained soluble fraction was then concentrated using either evaporation or using ultrafiltration (ceramic membrane, 5 kDa molecular weight cut off). The evaporated supernatant was used as a dissolved pea protein emulsifier and the ultrafiltration retentate was used as a dissolved pea protein emulsifier. Emulsions using the formula of Table 1 were made as described in Example 2 to have 2% total protein content from the evaporated dissolved pea protein emulsifier or the ultrafiltration dissolved pea protein retentate. FIG. 3 graphs the oil droplet size distribution of the emulsions using one of the evaporated and ultrafiltered dissolved pea protein measured after the emulsions were stored for 24 hours at about 4° C. Oil droplet size (microns) is on the x-axis and percent of the distribution of the oil droplets is plotted on the y-axis. As seen in FIG. 3, the emulsion made using evaporated dissolved pea protein isolate had generally smaller oil droplet sizes than emulsions made using ultrafiltred dissolved pea protein emulsifiers despite equal protein content in the emulsion.

### EXAMPLE 5—SALT REMOVAL FROM PEA PROTEIN EMULSIFIERS

Effect of salt removal and protein concentration on pea protein emulsifiers was explored. Generally the process to obtain the pea protein emulsifiers had three steps: 1) isolating a dissolved fraction of pea protein from a pea flour to obtain a raw pea protein emulsifier; 2) splitting raw emulsifier into six samples; and 3) subjecting the raw emulsifier to one or more of evaporative concentration and dialysis.

Raw pea protein emulsifiers were made as follows. Pea flour was rehydrated by dispersing it in room temperature water (1:3 to 1:10 parts, w/w flour to water, 15 minutes) and was adjusted pH to 9.0 (pH 8-10, 3M NaOH); stirred for 30 minutes. The dispersion was then centrifuged 10 minutes (1000×g) and decanted to form supernatant (1) and a precipitate. The precipitate was reslurried in water at a ratio of from about 1-part precipitate to 1- to 1.3-parts water w/w. The reslurried precipitate was again adjusted to pH 9.0, centrifugation (10 min. at 1000×g) to obtain a second precipitate and a second supernatant. The second precipitated was not used further in this example. The two recovered supernatants were combined, heated in water bath to 50-65° C., adjusted to target pH to 4.5 (pH 4-5) using 3M HCl, stirred for 30 minutes, and centrifuged (5000×g) for 15 minutes to obtain a third supernatant and a third precipitate. The third supernatant was decanted, and the third precipitate was reslurried (1-part precipitate to 1- to 1:3-parts water, w/w) and the slurry was again stirred for 15 minutes and centrifuged (5000×g, 15 min) to obtain a fourth supernatant and a fourth precipitate. The fourth precipitate was not used further, and the fourth supernatant combined with the third supernatant. The combined third and fourth supernatants were adjusted to a target pH of 6.5 (pH 6-7) using 3M NaOH) to form a raw pea protein emulsifiers.

Raw pea protein emulsifiers were further processed by evaporation or dialysis or both. Evaporated samples were prepared by using a rotary evaporator for 5 hours at one of 55° C., 75° C. or 95° C. Dialyzed samples were subjected to dialysis for either 24 or 48 hours. For the 24-hour dialyzed samples, approximately 0.2 kg of pea protein emulsifier was placed in one of four dialysis flasks (ThermoFisher Slide-A-Lyzer 3.5 kDa molecular weight cut-off, 230 mL dialysis flask), which were floated in 36 kg of water at 4° C. for 24 hours. Water was changed every 3 hours for the first 6 hours and was not changed for the last 18 hours. For 48-hour dialyzed samples, batches were dialyzed the same way for the first 24 hours. After 24 hours of dialysis, water was changed every 3 hours for the next 6 hours but not changed for the final 18 hours.

As a result of 24 hours of dialysis, the conductivity of the pea protein emulsifier samples decreased from about 5.2 to about 5.3 mS/cm to from about 0.99 to about 1.1 mS/cm. As a result of 48 hours of dialysis, the conductivity of the pea protein emulsifier samples decreased from about 5.3 to about 6.1 mS/cm to around about 0.59 to about 0.64 mS/cm.

In all, six samples of pea protein emulsifier were made. Samples that were dialyzed and concentrated were dialyzed first. Sample 1 was concentrated for 5 hours at 55° C. but was not dialyzed. Sample 2 was concentrated for 5 hours at 95° C. but was not dialyzed. Samples 3 and 4 are identical. Both were dialyzed for 24 hours and were concentrated at 5 hours at 75° C. Sample 5 was dialyzed for 48 hours and was concentrated at 55° C. for 5 hours. Sample 6 was dialyzed for 48 hours and concentrated for 5 hours at 95° C. The sodium content of the samples is reported in Table 3.

TABLE 3
Sodium contents of pea protein emulsifiers
after dialysis and concentration.

| | Dialysis | Concentration | Sodium |
|---|---|---|---|
| Sample | Time (h) | Temperature (° C.) | (wt. %) |
| 1. Sample 0-55 | 0 | 55 | 2.25 |
| 2. Sample 0-95 | 0 | 95 | 2.38 |
| 3. Sample 24-75A | 24 | 75 | 1.25 |
| 4. Sample 24-75B | 24 | 75 | 1.20 |
| 5. Sample 48 55 | 48 | 55 | 0.78 |
| 6. Sample 48-95 | 48 | 95 | 1.10 |

### EXAMPLE 6—PERFORMANCE OF DIALYZED PEA PROTEIN EMULSIFER

The emulsification potential of dialyzed dissolved pea protein emulsifier was tested in a spoonable dressing formulations that were standardized to contain 1% emulsifier solids and 75% oil. The formulation is provided in Table 4.

TABLE 4
Emulsion formula for used for analysis
of dialyzed pea protein emulsifiers

| Ingredient | Formula |
|---|---|
| EDTA | 0.01 |
| Potassium sorbate | 0.10 |
| Salt | 1.00 |
| Sugar | 3.00 |
| Water | 12.31 |
| Vinegar (120 Grain) | 3.00 |
| Liquid Dissolved Pea Protein Emulsifier (1% solids) | 5.78 |
| Soybean Oil | 75.00 |
| Total | 100.00 |

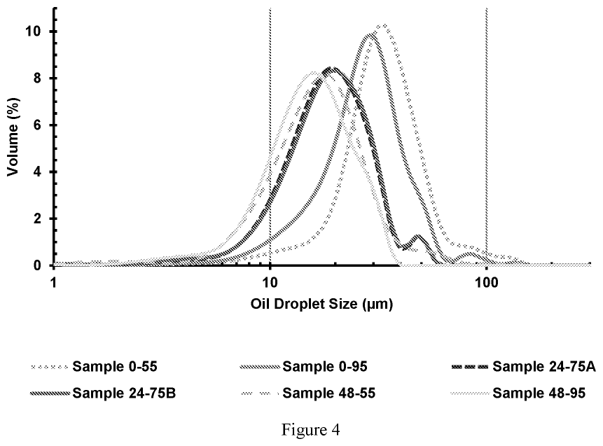

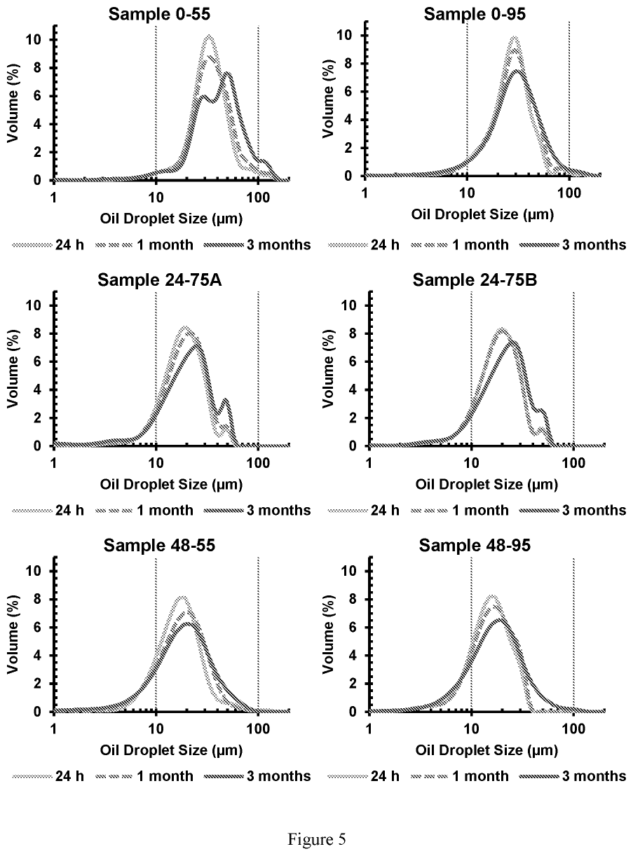

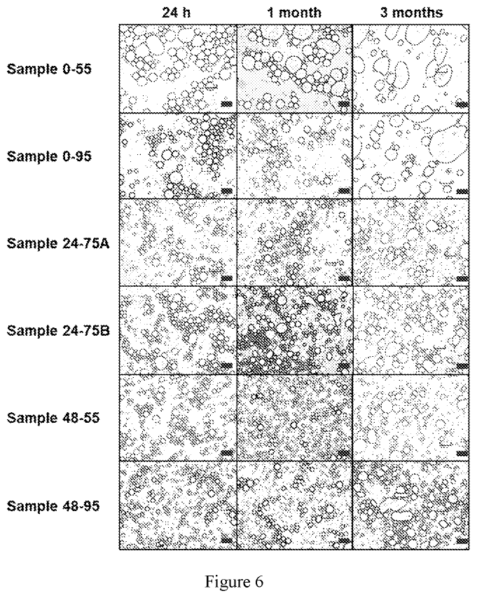

Emulsions were made using the method of Example 2. Emulsions were made, each using one of the each of pea protein emulsifier samples 1 through 6. Each emulsion made was separated into at least two samples, one being stored at 5° C., and the other at 25° C. Oil droplet size distribution was measured for each of the 5° C. stored sample and the 25° C. stored sample at 24 hours, 1 month and 3 months. The oil droplet distribution of all samples after storage at 25° C. for 24 hours is plotted in FIG. 4, which plots oil droplet size in microns along the x-axis and percent of the distribution of oil droplets is along the y-axis. FIG. 5 plots the change in oil droplet size distribution for each sample after storage at 25° C. for 24 hours, 1 month, and 3 months. Oil droplet size in microns is plotted along the x-axis and percent of the distribution of the oil droplets is plotted along the y-axis. FIG. 6 is a picture, 200× magnification light microscopy, of oil droplets within the aqueous phase for emulsions stored at 25° C. for 24 hours, 1 month, and 3 months. The oil droplet size for samples stored and at 25° C. for 24 hours and at 5° C. or 25° C. for 3 months is reported in Table 5.

TABLE 5
Oil Droplet Size of Emulsions made using
Dialyzed Pea Protein Emulsifier

| | Mean oil droplet | Mean oil droplet | Mean oil droplet |
|---|---|---|---|
| | size after storage | size after storage | size after storage |
| | at 25° C. for | at 25° C. for | at 5° C. for |
| Sample | 24 hours | 3 months | 3 months |
| 1. Sample | 36.93 | 47.30 | 38.32 |
| 0-55 | | | |
| 2. Sample | 30.01 | 34.71 | 27.73 |
| 0-95 | | | |
| 3. Sample | 20.36 | 22.80 | 20.14 |
| 24-75A | | | |
| 4. Sample | 20.63 | 23.68 | 21.48 |
| 24-75B | | | |
| 5. Sample | 19.85 | 22.46 | 16.66 |
| 48-55 | | | |
| 6. Sample | 16.53 | 21.21 | 16.50 |
| 48-95 | | | |

As seen in FIGS. 4, 5, and 6 and Table 5, reducing the salt content of the pea protein emulsifier further improved emulsion equality as measured by initial mean oil droplet size and changes in mean oil droplet size over time. That is, the samples containing smaller percentages of salt content provided emulsions with smaller mean oil droplet sizes when initially made and retained smaller mean oil droplet sizes at 24 hours, 1 month, and 3 months, when compared to the samples containing larger percentages of salt content.

1. A dissolved pea protein emulsifier comprising: pea protein dissolved in an aqueous solution,
wherein the dissolved pea protein has a molecular weight distribution of proteins wherein at least 5% (by weight of the emulsifier) of dissolved proteins in the distribution have a molecular weight greater than about 30 kDa
wherein the dissolved pea protein has a molecular weight distribution of proteins wherein about 5% to about 20% (by weight of the emulsifier) of dissolved proteins in the distribution have a molecular weight between about 30 kDa and 40 kDa.

2. The dissolved pea protein emulsifier of claim 1 having a sodium content or a potassium content less than about 1.5% by weight of the emulsifier.

3. The dissolved pea protein emulsifier of claim 1 having a pea protein content of greater than a from about 10% to about 40%.

4. The dissolved pea protein emulsifier of claim 1 wherein the emulsifier is made by a process comprising:
(i) obtaining a dispersion of a milled pea protein source having a pea starch and a pea fiber in an aqueous solution wherein the dispersion has a pH greater than about 8 or dispersing the milled pea protein source in an aqueous solution and adjusting the pH of the solution to a pH greater than about 8 to dissolve a portion of the pea protein, forming a first dissolved portion;
(ii) separating starch and fiber from the first dissolved portion;
(iii) adjusting the pH of the first dissolved portion to from about 4 to about 5 to precipitate a portion of the protein in the first dissolved portion, forming a second dissolved portion and a precipitate;
(iv) separating the precipitate from the second dissolved portion; and
(v) adjusting the pH of the second dissolved portion to about 6 to about 8 to obtain the aqueous composition.
wherein the emulsifier is made by a process does not include a hydrolysis step, a microfiltration step, an ultrafiltration step, or a reverse osmosis step.

5. An oil-in-water emulsion comprising:
a) an oil;
b) a dissolved pea protein emulsifier and
c) an aqueous ingredient;
wherein the oil and dissolved pea protein emulsifier are in an oil-to-dissolved pea protein ratio of about 0.01-part pea protein to about 1-part oil (by weight of the emulsion)
wherein the emulsion is egg free.

6. The emulsion of claim 5 wherein the oil is used in an amount in a range selected from the group consisting of:
a) greater than about 65% (by weight of the emulsion), or from about 65% to about 80% or from about 60% to about 75%, or from about 70% to about 75%; and
b) from about 25% to about 50% (by weight of the emulsion), or from about 25% to about 40% or from about 25% to about 35%.

7. The emulsion of claim 5 wherein the dissolved pea protein is used in an amount of from about 0.70% to about 2.0% by weight of the emulsion or from about 0.8% to about 1.5% by weight of the emulsion.

8. The emulsion of claim 5 further having no added starch.

9. The emulsion of claim 5 having a mean oil droplet size of less than about 10 microns.

10. The emulsion of claim 5 wherein the emulsion does not comprise a hydrocolloid or modified starch.

11. A method of making a pea protein emulsifier comprising:
a. obtaining an aqueous composition comprising dissolved pea protein and having a pH of from about 6 to about 8; and
b. concentrating the aqueous composition to have a pea protein content of greater than about 10%;
wherein the method does not comprise a microfiltration step or ultrafiltration step or reverse osmosis step.

12. The method of claim 11 wherein the method does not comprise a dialysis step.

13. The method of claim 11 wherein the emulsifier has a sodium content or a potassium content less than about 1.5% by weight of the emulsifier.

14. The dissolved pea protein emulsifier of claim 11 wherein the process further comprises:
prior to the obtaining the aqueous composition step:
(i) dispersing a milled pea protein source having a pea starch and a pea fiber in an aqueous solution having a pH greater than about 8 or dispersing the milled pea protein source in an aqueous solution and adjusting the pH of the solution to a pH greater than about 8 to dissolve a portion of the pea protein, forming a first dissolved portion;
(ii) separating starch and fiber from the first dissolved portion;
(iii) adjusting the pH of the first dissolved portion to about 4 to about 5 to precipitate a portion of the protein in the first dissolved portion, forming a second dissolved portion and a precipitate;
(iv) separating the precipitate from the second dissolved portion; and
(v) adjusting the pH of the second dissolved portion to about 6 to about 8 to obtain the aqueous composition.

15-20. (canceled)
